(19) United States
(12) Patent Application Publication
(10) Pub. No.: US 2003/0171978 A1
(43) Pub. Date: Sep. 11, 2003

(54) Efficient retail item assortment

(76) Inventors: Margalyn Toi Jenkins, St. Louis, MO (US); Keith William Kornfeld, Ballwin, MO (US)

Correspondence Address: Evan R. Sotiriou, Harness, Dickey & Pierce, P.L.C., Suite 400, 7700 Bonhomme, St. Louis, MO, 63105, US

(21) Appl. No.: 10/279,505

(22) Filed: Oct. 24, 2002

Related U.S. Application Data
(60) Provisional application No. 60/363,325, filed on Mar. 11, 2002.

(51) Int. Cl. G06F 17/60

(52) U.S. Cl. 705/10

(57) ABSTRACT

A system and method for selecting products for retail sale provides ranking data for use in product selection. Worksheets provide for comparison to consumer preference data. Data is provided in the worksheets to allow for easy evaluation to determine a sales threshold based upon the ranking data and provided in combination with the consumer preference data.

### CROSS-REFERENCE TO RELATED APPLICATIONS

This application claims the benefit of U.S. Provisional Application No. 60/363,325 filed Mar. 11, 2002, the entire disclosure of which is incorporated herein by reference.

### FIELD OF THE INVENTION

The present invention relates generally to identifying and selecting specific products for retail sale, and more particularly to analyzing a group of products in order to optimize specific attributes.

### BACKGROUND OF THE INVENTION

Efficient item assortment processes are generally implemented to provide for the selection of products, typically identified by a Stock Keeping Unit (SKU), based on specific factors or criteria (e.g., dollar sales) in an attempt to achieve a retailer's objectives for a particular category of goods. These objectives may include, for example, target consumer need fulfillment, overall retail portfolio strategic alignment and/or financial returns.

Essentially, a SKU optimization is performed to meet distribution objectives. Conducting an efficient item assortment provides for distribution of products, including key performance indicator products. Typically, such a process is performed when growth of a particular sub-category of products (e.g., a smaller group of related products) is flat to declining. An efficient assortment process is then conducted to identify specific products to add or remove for retail sale in order to, for example, increase sales and/or provide for efficient pack-out to eliminate out of stock (OOS) products. In particular, it is typically important to align product assortment with the market and competition. If the product assortment is not aligned, then items with low turn-around and high days-of-supply are deleted, and products that contribute a high dollar share to the category are added.

Known systems for providing an efficient item assortment process use sales data to determine a group of products for retail sale. This sales data may include, for example, percentage sales data for a class of products or cumulative sales for that class.

It is typically important to continually review and evaluate product assortments used to determine specific products to provide for retail sale in order to maximize desirable factors (e.g., sales) and minimize undesirable factors (e.g., days of supply of product on shelf). As recognized by the inventors hereof, it would be useful to provide an efficient item assortment process that utilizes consumer preference data. It is also useful for a system for use in evaluating product assortments to allow for easy and efficient item assortment to determine products within a particular category that should be provided for retail sale, including any changes (e.g., addition or deletion of products) that need to be made. Further, it is important that such a system allow for comparison of different types of data.

### SUMMARY OF THE INVENTION

The present invention provides a system and method for efficient item assortment that facilitates the evaluation of a product group, including allowing for evaluation with respect to sales and consumer preference data. Performing an efficient item assortment using the present invention is essentially a best practice process to allow for maximizing variety while eliminating duplicative products.

Specifically, in one embodiment of the present invention a method for evaluating information relating to a group of products for assisting a user in selecting at least some of the products for retail sale includes ranking products within a predetermined product class based upon sales data, determining a sales threshold for the ranked products, evaluating ranked products falling within a predetermined range of the sales threshold with reference to consumer preference data, and selecting products for sale based upon the evaluation. The sales threshold may include a combined sales threshold.

In another embodiment of the present invention, a computer implemented method for processing product and consumer preference information to assist a user in evaluating a group of products to select at least some of the products for retail sale is provided. The method includes receiving the product and consumer preference information relating to each product within the group of products, processing the product and consumer preference information to rank the products within a predetermined product class based upon sales data, and displaying the ranked product information for use in determining a sales threshold for the ranked products and evaluating the ranked products falling within a predetermined range of the sales threshold with reference to the consumer preference data to select products for retail sale. The product and consumer preference information may be displayed on at least one worksheet.

In yet another embodiment of the present invention, a system for processing product and consumer preference information relating to a group of products includes an interface for receiving product and consumer preference information, and a processor configured to process the product and consumer preference information to produce ranked product information for display in combination with at least some of the product and consumer preference information. The processor may be configured to produce the ranked product information for display as part of a worksheet in combination with at least some of the product and consumer preference information, with the worksheet adapted for modification by a user.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow chart of a process for providing an efficient item assortment system according to the present invention;

FIG. 2 is a block diagram illustrating in more detail the process of FIG. 1;

FIG. 3 is a block diagram of a system of the present invention for providing efficient item assortment;

FIG. 4 is a block diagram illustrating a process for generating output data according to the present invention;

FIG. 5 is an exemplary assortment decision worksheet of the present invention;

FIG. 6 is an exemplary market fragmentation worksheet of the present invention;

FIG. 7 is an exemplary target consumer worksheet of the present invention;

FIG. 8 is an exemplary market assessment worksheet of the present invention;

FIG. 9 is an exemplary sales and profit productivity worksheet of the present invention;

FIG. 10 is an exemplary tactogram worksheet of the present invention;

FIG. 11 is an exemplary assortment decision worksheet of the present invention having a market sales coverage percentage line indicated therein;

FIG. 12 is an exemplary finalization worksheet of the present invention;

FIG. 13 is another exemplary finalization worksheet of the present invention;

FIG. 14 is an exemplary additions worksheet of the present invention;

FIG. 15 is an exemplary deletions worksheet of the present invention; and

FIG. 16 is a schematic diagram of an exemplary computer device for implementing the efficient item assortment process of FIG. 1.

### DETAILED DESCRIPTION OF PREFERRED EMBODIMENTS

The following description of the preferred embodiments is merely exemplary in nature and is in no way intended to limit the invention, its application, or uses. Thus, although the present invention is disclosed in connection with determining an assortment of specific types of products using a particular set of factors, it is not so limited, and the present invention may be used to determine an assortment of other types of products using different or additional factors.

In general, the present invention provides an assortment process that is performed for category management by identifying the category definition (e.g., Pet Care vs. Dog Food), segmenting the category using consumer information, and determining category role and strategy to provide overall objectives (e.g., increase sales). Essentially, a top-down approach is provided by utilizing role and strategy guidelines as factors when determining product SKU deletions, retentions, and additions. A combination of IRI, market data available from Information Resources, Inc., (e.g., overall market sales data and specific retailer sales data for particular products, which may include dollar sales and unit data) retailer movement and profit data, and consumer data (e.g., Nielsen loyalty/switching and Spectra 5 standard consumer types) is used.

An efficient assortment process provided by the present invention generally includes the following:

1. Assembling data (e.g., consumer, market, distributor and competition data).

2. Ranking product SKUs by dollar sales within a class (e.g., a sub-segment) of products (e.g., super premium dry dog food). Role and strategy guidelines are preferably provided, along with market, distributor, consumer, and competitor measures to determine a sales threshold (e.g., preliminary market sales coverage percentage value) that defines an evaluation line (e.g., add/delete/retain line).

3. Evaluating product SKUs falling within a predetermined range (e.g., dollar range closest to the line based upon sales) relative to the evaluation line and thereafter making assortment decisions (e.g., to add, delete or retain a product).

4. Validating assortment decisions. Strategy and market sales coverage objectives are confirmed, and sales and profits are estimated for SKU additions and deletions.

A category definition is determined, then category structure market sales coverage percentages are established for each sub-segment for the category structure (e.g., at the class level), to determine which items to delete, retain, and/or add. The resulting assortment then may be quantified and compared to a current assortment.

Specifically, a SKU ranking process is first provided. In particular, a sales threshold (e.g., a market sales coverage percentage line or evaluation line) is determined for each sub-segment (e.g., price class), the market product SKUs are ranked within each sub-segment, the current product SKU offering is matched-up with the product SKU for the market offering, then the product SKUs are reviewed and evaluated. The review and evaluation is preferably performed within a range above and below the evaluation line to determine deletions, additions, and retentions. Different information may be used to further identify specific products to delete, add or retain, including, for example, consumer, market, distributor, and competitive measures. After a determination has been made as to changes to the products selected, the assortment may be quantified as described herein.

Essentially, determinations are made at the sub-segment level (e.g., price class level, such as premium dry dog food) versus product form level (e.g. dry dog). The price class level or sub-segment level provides for close alignment with consumer segmentation that allows for a determination as to which class of products should receive more or less variety (e.g., market sales coverage percentage) based upon a target consumer group, using, for example, Spectra's 5 standard consumer types as described herein. The larger classes of products, for example, from a dollar sales perspective, receive larger market sales coverage percentages than smaller classes of products. Further, when making add/delete/retain decisions, Nielsen panel measures (e.g., loyalty and switching) allow for a determination as to which product SKUs potentially offer variety and which may be duplications. Finalization worksheets allow for checking decisions against key attributes in the consumer decision making process and evaluating the recommended assortment by class, brand, size or flavor groupings.

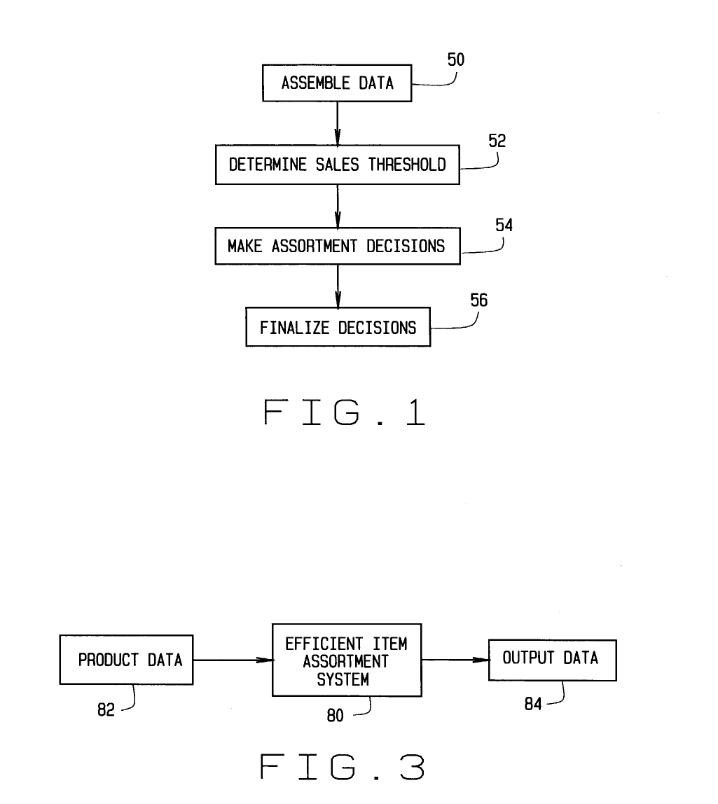

In particular, an assortment process of the present invention is shown generally in FIG. 1. Specifically, data (e.g., consumer, market, distributor and competitive data) is assembled at 50 to provide worksheets as described herein. Based upon the assembled data and using the worksheets, a sales threshold (i.e., evaluation line) is determined at 52. An evaluation and analysis is performed relating to products in a particular class of goods at 54 based upon the evaluation line and using information provided in the worksheets. Preferably, this evaluation and analysis is performed for products that are within a predetermined range (e.g., dollar sales amount) of the sales threshold or evaluation line. After the evaluation and analysis is performed, the results and decisions are finalized at 56, which may include providing a final report. A system of the present invention as described herein may be configured to allow for these steps to be performed electronically (e.g., on a graphical user interface (GUI) displayed on a monitor of a computer system).

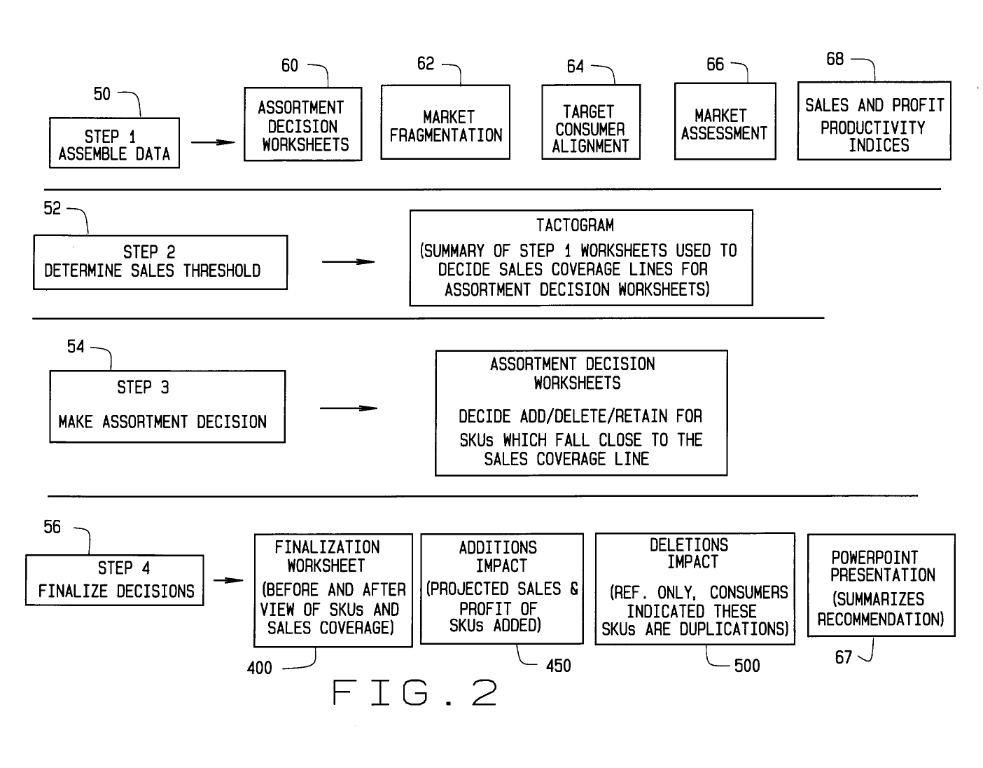

With respect to assembling data at 50, data from various sources may be used, and as shown in FIG. 2, is assembled to provide worksheets that include assortment decision worksheets 60, market fragmentation worksheets 62, target consumer alignment worksheets 64, market assessment worksheets 66 and sales and profit productivity worksheets 68. With respect to determining a sales threshold line at 52, tactograms as described herein are preferably used. Thereafter, when making assessment decisions at 54, modified assortment decision worksheets are used. Upon making a decision, recommendations are finalized that may include generating a finalization worksheet 400, additions impact worksheets 450, deletions impact worksheets 500 and other presentations 67. When reference is made herein to worksheets, this refers to output data organized, for example in a spreadsheet format, to provide information for display regarding the products being analyzed.

As shown in FIG. 3, an efficient item assortment system 80 of the present invention assembles and integrates data 82 (e.g., product data) electronically to produce output data 84 for display. The system 80 may be implemented using any suitable electronic and control means (e.g., computer) to execute the processes described herein.

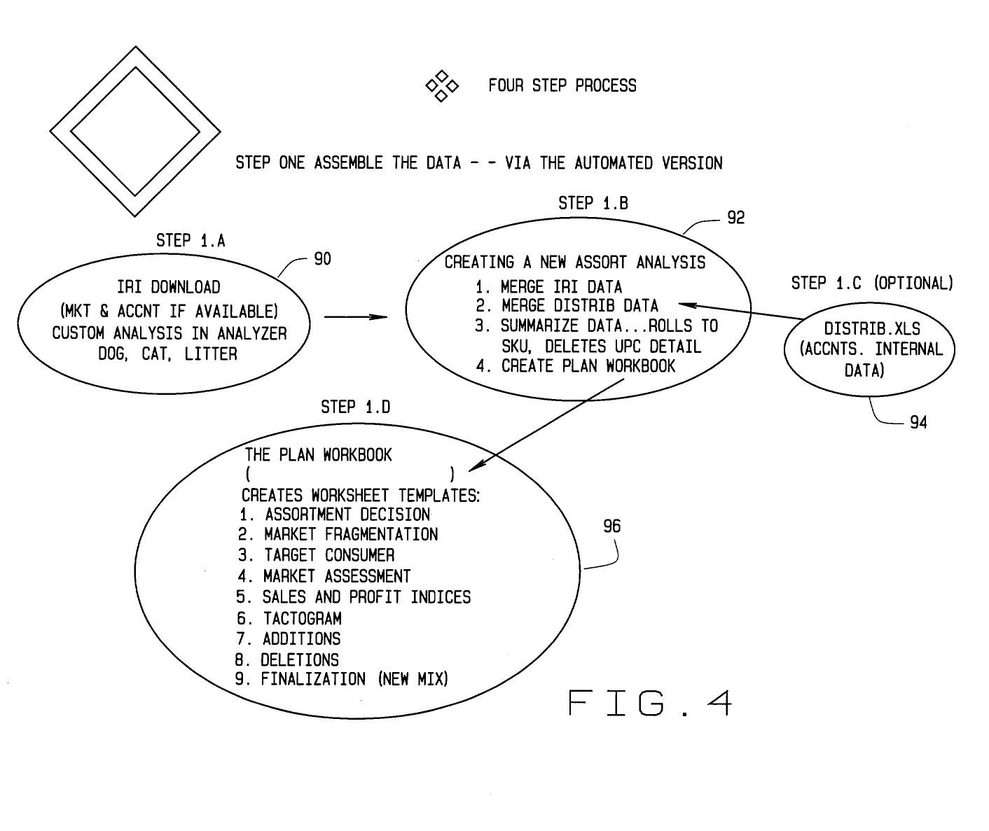

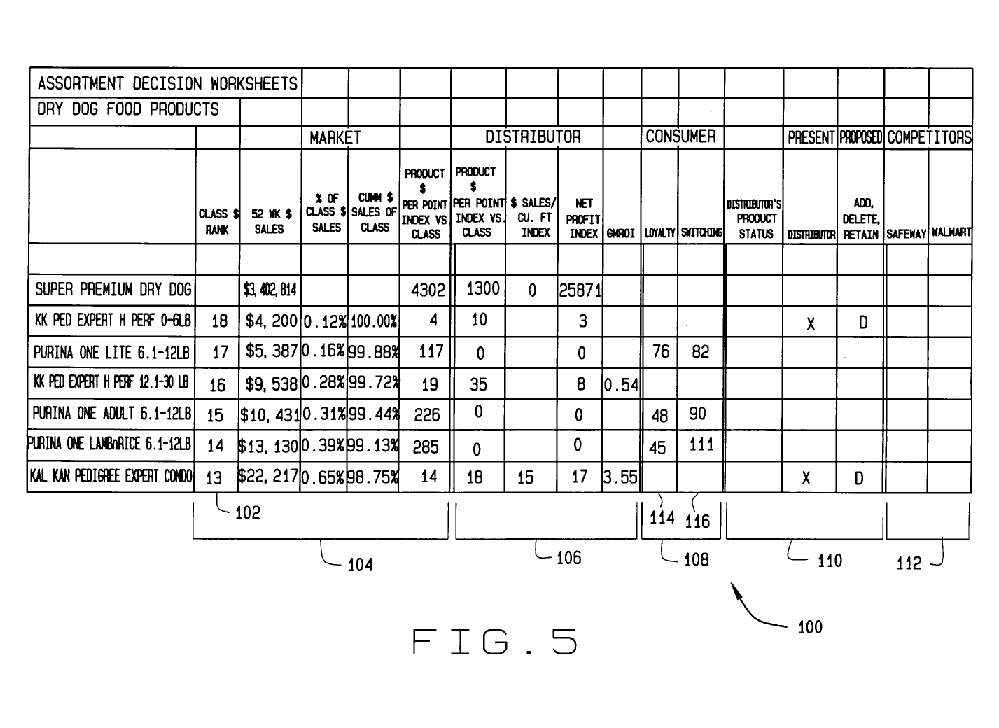

As shown in FIG. 4, data 82 (e.g., IRI data) is downloaded at 90. The data 82 is then merged at 92, for example, into a single spreadsheet. Internal account data may also be merged at 94. Thereafter, a plan workbook is created at 96 that includes a plurality of worksheets as described herein.

Different types of data 82 may be provided at 90 and may include, for example:

1. IRI data, such as market dollar sales and one year ago (YAGO) information; IRI account dollar sales and/or YAGO information; market and distributor (Account) ACV per point of distribution information; market and distributor (Account) dollar market shares and change versus YAGO information.

2. Distributor data, such as dollar sales, dollar profit, dollar sales and profit per cubic feet, GMROI, and product distribution status, which may include current distribution, new distribution, recent discount, and limited distribution data. It should be noted that if dollar sales per cubic feet, profit per cubic feet, or GMROI at the SKU level are not available, then unit numbers and a planogram (e.g., Apollo planogram) can be used to calculate these measures.

3. Consumer data such as loyalty index via the Nielsen Panel, switching index via the Nielsen Panel, and consumption indices via Spectra's 5-Standard Consumer Types.

4. Competitor data, such as store audits of target competitors' current distribution.

The downloaded data 82 is used by the system 80 to generate output data 84, shown in the figures in spreadsheet form. However, the output data 84 may be displayed in other forms, such as graphs. With respect to the output data 84, and for example, dollar profit at the UPC level is used to determine a net profit index, profit projections and GMROI. Alternate sources of information also may be used. For example, if percentage sales and/or profit information is not available, then IRI account dollar sales may be used. However, in such cases, other factors may be included. For example, another way to calculate profit (e.g., gross margin percentage) may be used or profit measures may not be used as decision criteria and, thus, will not be used in estimating the value of new item additions.

The system 80 may also use information assembled by other sources, such as, for example, the Apollo Suite 8.0 shelf management tool available from Information Resources, Inc. (“Apollo”). For example, because UPC information is rolled-up to SKU level (e.g., using an automated process), and because GMROI is not an additive measure, the GMROI calculation may be calculated via Apollo. Other modifications may be necessary in such a case. For example, if Apollo is used to calculate GMROI, then 52 week or 24 week units are obtained in addition to an average Apollo store planogram, that allows for calculating turns.

In one embodiment of the present invention, when assembling data at 50, output data 84 is generated for display. Specifically, an assortment decision worksheet 100 is generated by the system 80 as shown in FIG. 5. The assortment decision worksheet ranks products in the market by dollar sales of a predetermined period (e.g., 52 weeks) within a product class (e.g., dry dog food) in a class rank column 102. As shown, other information relating to the products in the class is provided, including generally, Market data 104, Distributor data 106, Consumer Panel data 108, SKU status data 110, and Target Competitor data 112, each displayed in separate columns of the spreadsheet. The information provided in the assortment decision worksheet 100 is used to determine adds/retains/deletes for specific products. Further, information from one worksheet may be provided to other worksheets. For example, data in the cumulative dollar sales of class (Cumm $ Sales of Class) column is used to create a market fragmentation worksheet 150.

Using the assortment decision worksheet 100 a loyalty index and a switching index can be determined. A loyalty index represents the share of an annual portion of requirements accounted for by a product among its purchasers, which is typically measured by product pounds purchased per year as a percentage of the total pounds for that portion purchased of the item. This is indexed against the average share of the portion requirements satisfied by the average item in the portion among its respective purchasers. For example, assume Dog Chow 4.4# and Kal Kan (KK) Mealtime 4.4# were the only two SKUs in the Dry Dog Premium Nutritional sub-segment. If Dog Chow 4.4 lb buyers buy 50 pounds on average per year and KK Mealtime buyers buy 35 pounds average per year, then the sub-segment average would be 42.5 lb=(50+34)/2. The indices for the two items would be 118 for Dog Chow 4.4 lb (50/42.5) and 82 for KK Mealtime 4.4 lb (32/42.5). The loyalty indices are displayed in the Loyalty column 114.

The switching index represents the average number of a portion of products purchased by a particular portion of the product's purchasers, which is typically measured by the number of different products purchased for that portion, regardless of the number of transactions. This is indexed against the average number of products in that portion purchased by the average item purchaser for that portion. Thus, if a purchaser purchases Dog Chow 4.4 lb. ten times, it would only be counted once. Essentially, the switching index is a penetration based measure that measures the “variety orientation” of a particular product SKU's purchaser. For example, and using the same two products as in the loyalty index calculation, if Dog Chow 4.4 lb. buyers buy a total of 4 Dry Dog Prem. Nutritional items per year and KK Mealtime 4.4 lb. buyers buy 8 items, the average for the portion would be 6=(4+8)/2. The indices for the two items would be 150 for Dog Chow 4.4 lb. (6/4) and 75 for KK Mealtime 4.4 lb. (6/8). The switching indices are displayed in the Switching column 116.

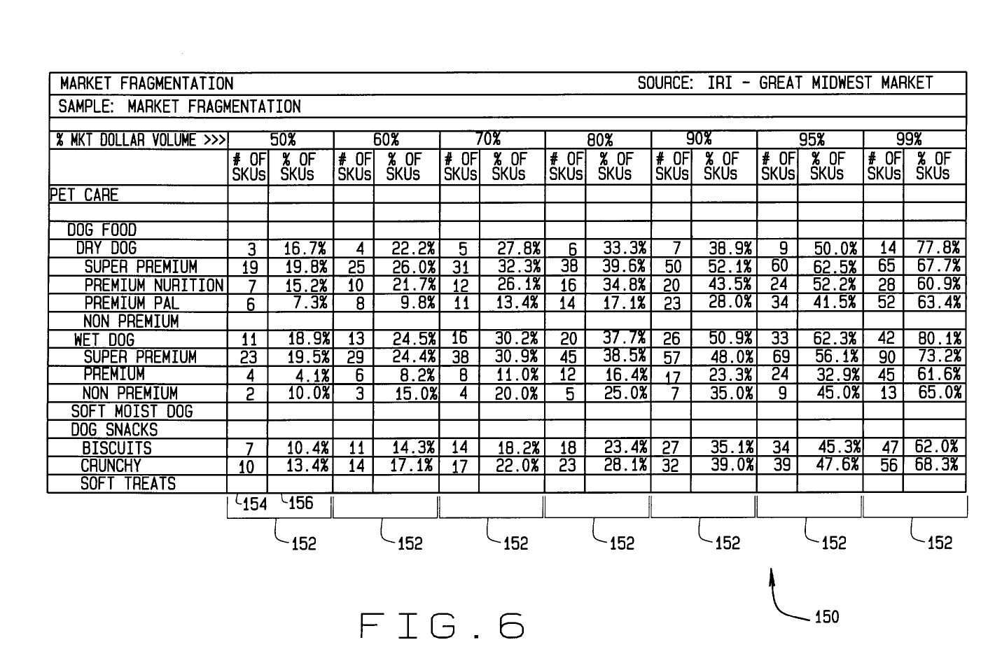

A market fragmentation worksheet 150 as shown in FIG. 6 is generated by the system 80, and displays by sub-segment, the number of products and the percentage of products required to achieve a specific market sales coverage percentage (e.g., 50% of market dollar volumes). Sub-segments 152 for each of the sales percentages are provided. For example, in the sub-segment 152 labeled 50%, column 154 shows the number of sub-segment products that add up to a 50% market sales coverage and column 156 shows the percentage of sub-segment products that add up to a 50% market sales coverage. From the market fragmentation worksheet 150 a determination is made as to how many products or what percentage of products in a class comprises a percentage of overall sales. Data from the assortment decision worksheet 100 may be used to create this spreadsheet.

Thus, and for example, three Super Premium Dry Dog products (or 16.7% of Super Premium Dry Dog products) are required to reach a 50% market sales coverage. Using this data allows for a determination of when the percentage increase in a product is not contributing an equivalent percent increase in dollar sales. For example, twenty-three (or 28%) of Non Premium Dry Dog Food products contribute 90% of the market dollar sales, but thirty-four (or 41.5%) of Non Premium Dry Dog Food products contribute to 95% of the market dollar sales. Thus, it takes an incremental 13.5% of this product (i.e., 28% to 41.5%) to achieve an additional 5% in market dollar sales (i.e., 90% to 95%).

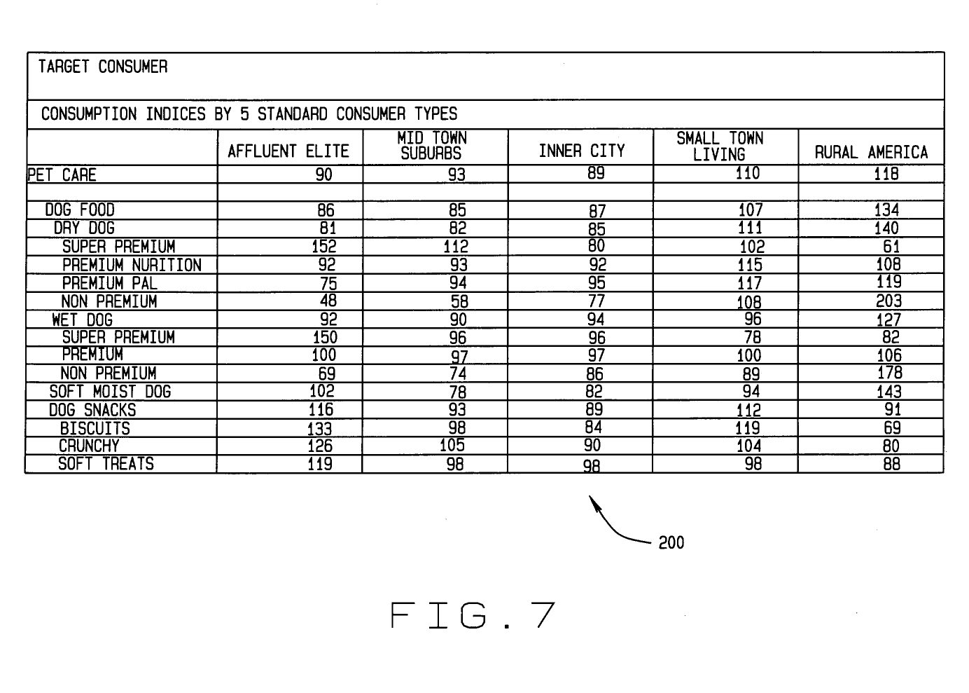

A target consumer worksheet 200 as shown in FIG. 7 is generated by the system 80 and displays consumption indices from the 5 standard consumer types provided by Spectra (i.e., Affluent Elite, Mid Down Suburbs, Inner City, Small Town Living and Rural America). Each index is based upon calculations relative to all consumers. The target consumer worksheet 200 is preferably generated for classes of products that are of higher importance to target consumers and thereby require additional sales volume coverage. The output data shown indicates whether consumers strongly or adversely align with the various classes of products displayed. The indices in the consumer type that most closely aligns to a particular geographical area of interest are imported (e.g., electronically copied) into the tactogram worksheet 350. Essentially, the target consumer worksheet 200 provides an index based upon profiles of brand and demographics of consumers, including their propensity to purchase.

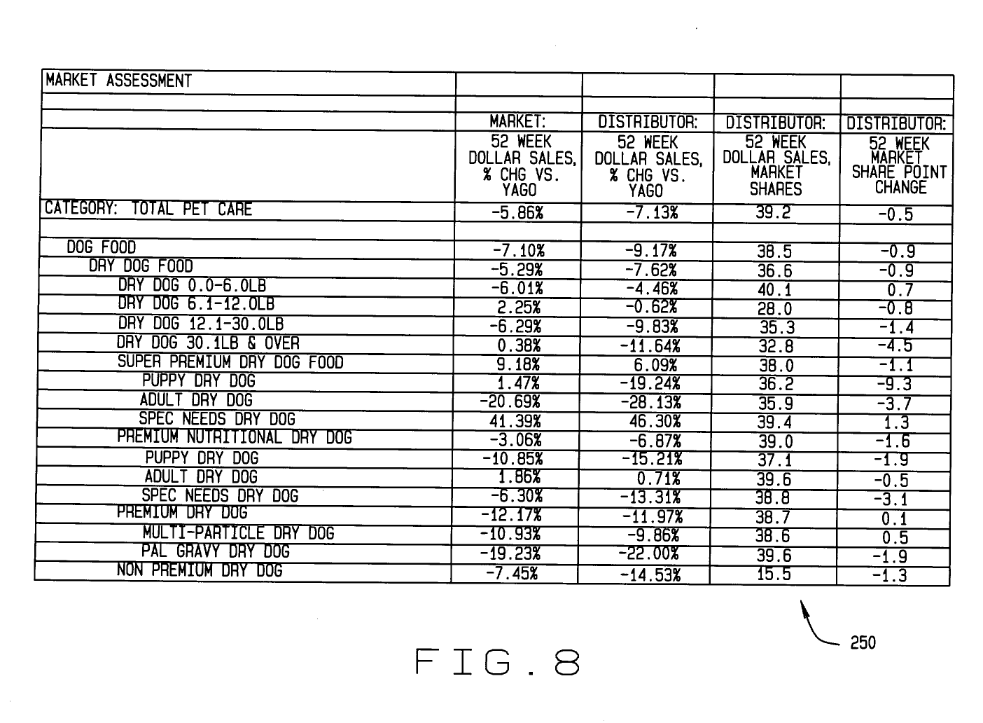

A market assessment worksheet 250 as shown in FIG. 8 is generated by the system 80 and generally displays dollar share and sales information. In particular, dollar sales percent change is compared to market data (e.g., YAGO and market shares). This information may be used to determine strengths and weaknesses in the product category and includes information for a predetermined period of time (e.g., 52 weeks). Essentially, size mix data is provided and allows for analysis of shifts or changes.

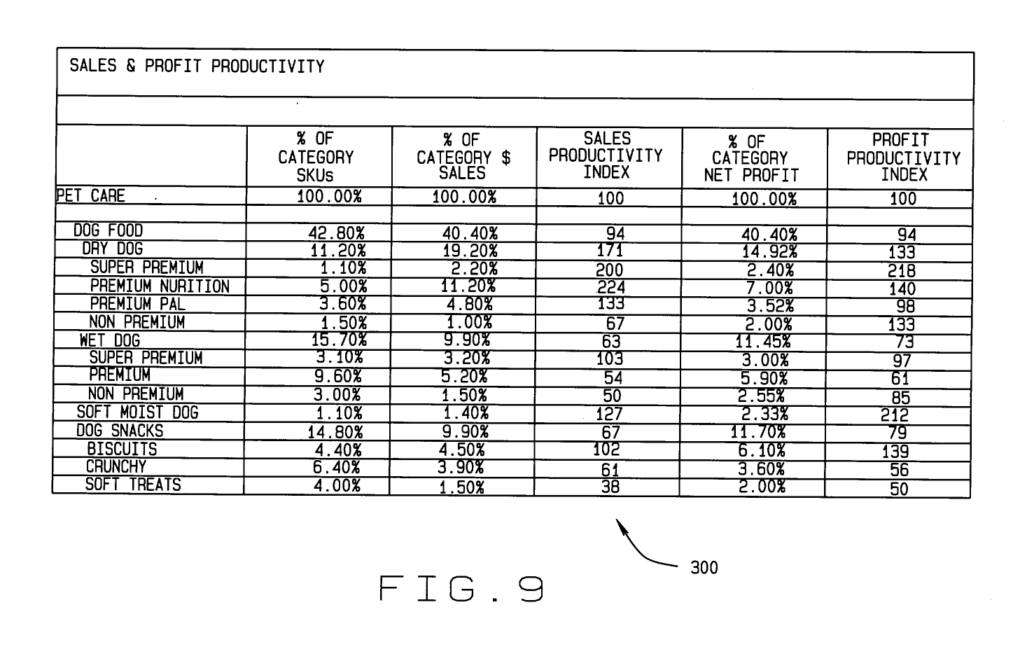

A sales and profit productivity worksheet 300 as shown in FIG. 9 is generated by the system 80 and generally displays sales and productivity information, which is generated from a particular distributor's data (e.g., account's internal data). The data provided is used to determine if a particular class of product delivers more sales and/or profit on percentage basis versus other classes, which indicates the need for larger sales coverage for the class depending on the strategy. In particular, the following calculation is performed: Percentage of Category % Sales (or Profits) for a class of product divided by the Percentage of Category Products (identified by SKUs) for that class of product.

Using the assembled data at 50 as described herein to produce output data 84 displayed in worksheets as described herein, a sales threshold is determined at 52. The sales threshold may be, for example, the percentage of market sales to be covered by a particular assortment. A sales threshold line (i.e., evaluation line) is defined within each class of products. Preferably, products falling within a predetermined range of the sales threshold line are evaluated for assortment decisions (e.g., additions, deletions, and retentions). It should be noted that the sales threshold may be based upon individual data or combined data. For example, product sales data relating to each product in a class of products may be used to determine the sales threshold, or a combination of product sales data for all products within a particular class of products (e.g., total sales for the products) may be used to determine the sales threshold.

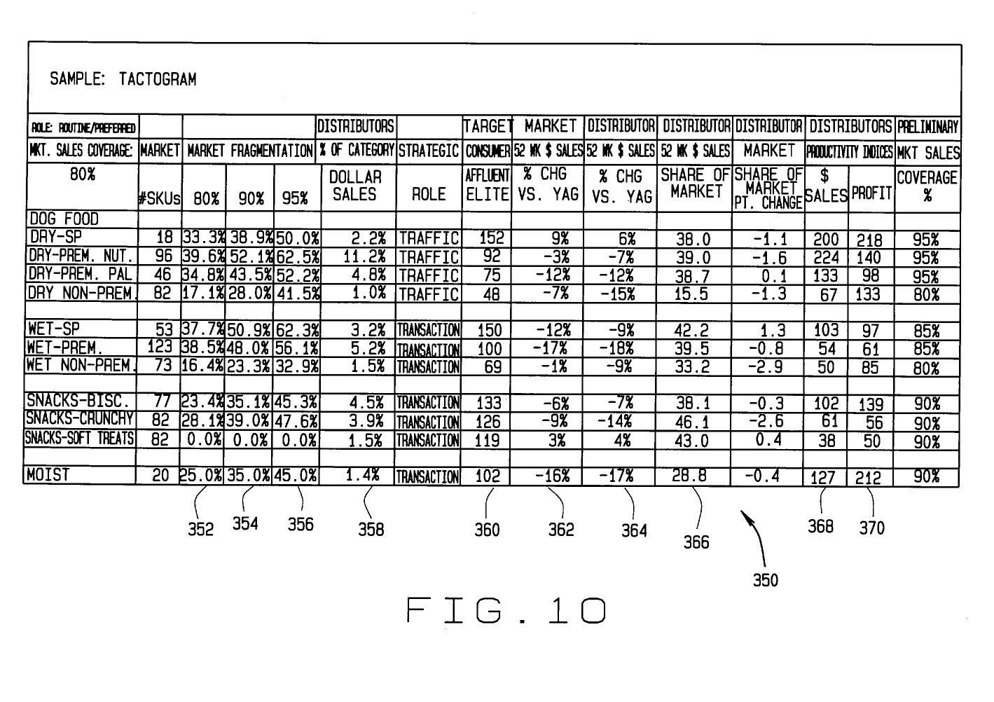

Information from the worksheets generated in 50 is used to create a tactogram 350 for determining the sales threshold line. Specifically, the tactogram 350 as shown in FIG. 10 is used to determine where the sales threshold line should be established for each class of products. The line is generally defined by a role and strategy impact on sales volume coverage (e.g., 90% for a Destination Category) as described herein. Using this, the tactogram 350 allows for adjustment within each class of products based upon the need for more or less market sales coverage. It should be noted that although the category objective is a defined percentage (e.g. 90%), not all sub-segments require the same percentage based on target consumer fulfillment, market opportunity, and distributor scorecard objectives. Thus, different factors affect the determination. For example, if the retailer aligns with an Affluent Elite consumer, then Super Premium sub-segments preferably should receive greater market coverage versus non Premium sub-segments.

In particular, and with respect to setting the sales threshold line at 52, the following steps are performed:

1. Develop the tactogram 350 using the system 80.

2. Review the category role, strategy, and scorecard measure/objectives.

3. Review the market coverage analysis for each sub-segment (e.g., target consumer alignment spreadsheet 200, Sales/Productivity indices from the sales and profit productivity worksheet 300, market fragmentation worksheet 150 and competitor stocking).

4. Set the sales threshold line for each sub-segment. The line should be indicated on the assortment decision worksheets 100.

With respect to developing a tactogram 350, information generated from the spreadsheets is used. The information used preferably includes the following:

1. The impact on market sales coverage percentage due to the selected role and strategies procedures described herein.

2. Market fragmentation information including the percentage of products, again identified by SKUs, in the marketplace required to achieve certain percentage sales volume coverage in the marketplace.

3. Dollar share of category sales by class.

4. Strategic role information.

5. Target consumer information (e.g., consumption indices by Spectra 5 Standard Consumer Types).

6. Market assessment information including market and distributor dollar sales percentage change versus YAGO, and distribution market shares and percentage change.

7. Dollar sales and profit productivity indices.

Using this information, a tactogram 350, preferably in spreadsheet form, is created as shown in FIG. 10. Using the tactogram 350 (e.g., reviewing the information provided thereon), a sales threshold line for each class of products is determined. Essentially, a user starts with a recommended coverage based upon the category role information described below, then increases or decreases the coverage relative to the various tactogram 350 measures. For example, a low productive fragmentation analysis (e.g., small amount of products doing majority of business as shown in the market fragmentation worksheet 150) at 70% indicates an action to decrease the market sales coverage percentage line is needed. A high target consumer alignment (e.g., 100+ index as shown in the target consumer worksheet 200), as well as a large percentage of category dollar sales (e.g., 10%) indicates an action to increase market sales coverage percentage line is needed.

When determining a sales threshold line, it is preferable to establish the line with the classes of product that have the highest alignment with the target consumer and largest class percentage of category dollar sales. Using the first sub-segment's market coverage percentage line, a benchmark is established for the remaining sub-segments to establish the market sales coverage percentage lines for those sub-segments.

The role and strategy impact on sales volume coverage is determined using the following rules:

| CATEGORY ROLE | IMPLIED SALES VOLUME COVERAGE |
|---|---|
| Destination | Complete coverage (i.e., 90%) of market |
| | sales coverage in all major strategy |
| | segments and sub-segments. |
| Routine | Broad coverage (i.e., 80%) of market |
| | sales coverage in all major segments |
| | (i.e., greater than 10% of category dollar |
| | sales) and significant coverage (i.e., |
| | 66%+) in small segments. |
| Seasonal/Occasional | Range from 33-66% market sales |
| | coverage dependent on segment size of |
| | category. |
| Convenience | Provide only a Limited offering of |
| | popular products to meet a broad range |
| | of consumer needs. |
| SEGMENT STRATEGY | IMPLIED SALES VOLUME COVERAGE |
| Traffic Building | Increase coverage in segments that |
| | have the highest share, highest target |
| | consumer indices and highest growth |
| | rates. |
| Profit Generating | Increase coverage in highest profit |
| | segments that have high target |
| | consumer indices. |
| Turf Protecting | Increase coverage of segments of the |
| | category that are growing fast, that are |
| | targeted specifically by the competition |
| | or in a segment in which the share |
| | percentage is declining. |
| Transaction Building | Increase coverage of larger sizes, high |
| | dollar product segments and have high |
| | target consumer indices |
| Excitement Creating | Increase coverage of fast growing |
| | segments that add novelty, topicality or |
| | eye appeal to the category. |

For example, based upon a particular role as described herein (e.g., Routine/Preferred), a sales threshold for the role (e.g., 80%) is selected, a class to benchmark from is determined (e.g., Dry Prem Nutr., which is the largest class and largest average target consumer), and then the market sales coverage percentage (i.e., sales threshold) is adjusted based upon market fragmentation data shown in columns 352, 354 and 356 for different percentages, percentage of category data shown in column 358, target consumer alignment data shown in column 360, market trends data as shown in column 362, and distributor dollar sales and profit data in columns 364, 366, 368 and 370.

After completing the tactogram 350 and determining the sales threshold lines for each “portion” or class of products (e.g., 95% sales coverage), the lines are indicated on each of the assortment decision worksheets 100, which may be provided manually by a user or electronically by the system 80. Products that are high in the dollar sales ranking (i.e., above the sales threshold line) and are not currently stocked are preferably automatically added to the mix. Products that are low in dollar sales ranking (i.e., below the sales threshold line) and are stocked, are preferably automatically deleted, unless an exception exists.

In a more preferred procedure, products within a predetermined range (e.g., the five closest) to the sales threshold line are evaluated to determine whether a change is necessary (e.g., add, delete or retain). The predetermined range may be determined by a trend analysis to define breaks across a plateau.

The various market, distributor, consumer, and competitor measures are used to evaluate the products to determine adds, deletes, or retains. This preferably includes evaluation of consumer preference data, such as, for example, consumer behavior, loyalty and switching data. The products with strong indices (e.g., above 100) across all of the measures and/or stocked by key competitors are preferably considered for addition and products with weak indices across all of the measures and/or not stocked by key competitors are preferably considered for deletion. Thus, the tactogram worksheet 350 combines data from the worksheets generated at step 50.

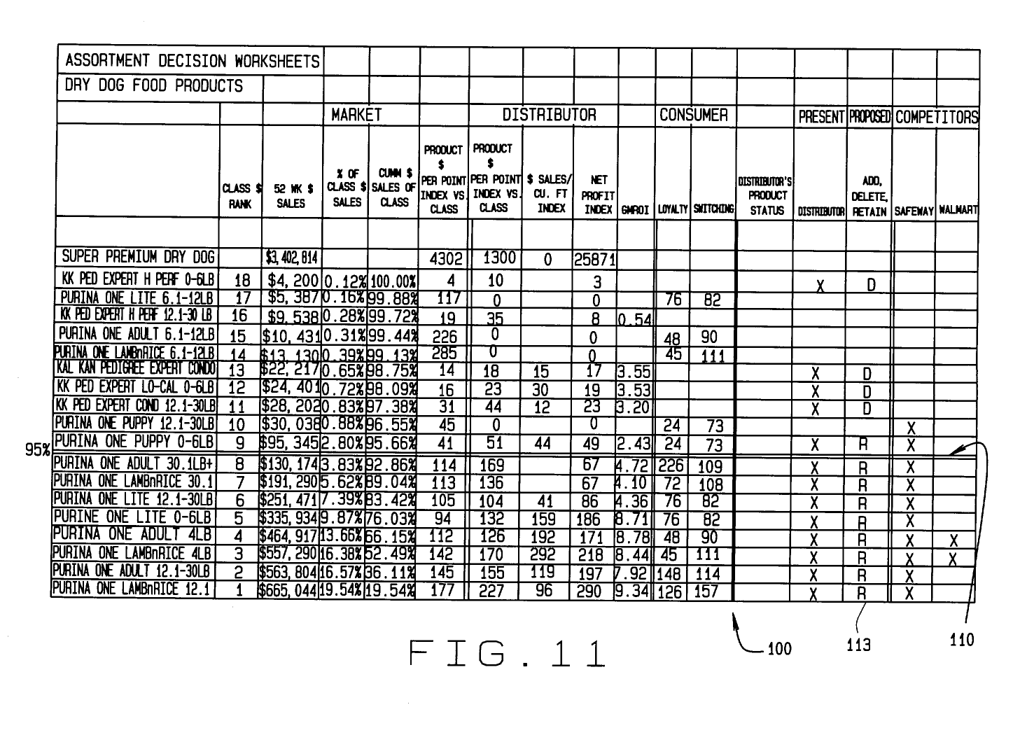

After determining a sales threshold line, a modified assortment decision worksheet 100 as shown in FIG. 11 is produced showing the sales threshold line 110, with product adds, deletes and retains indicated in a Proposed Add, Delete, Retain column 113. This is similar to the assortment decision worksheet 100 as described herein with additional information added thereto (e.g., sales threshold line 110 and additional indications of adds, deletes and retains)

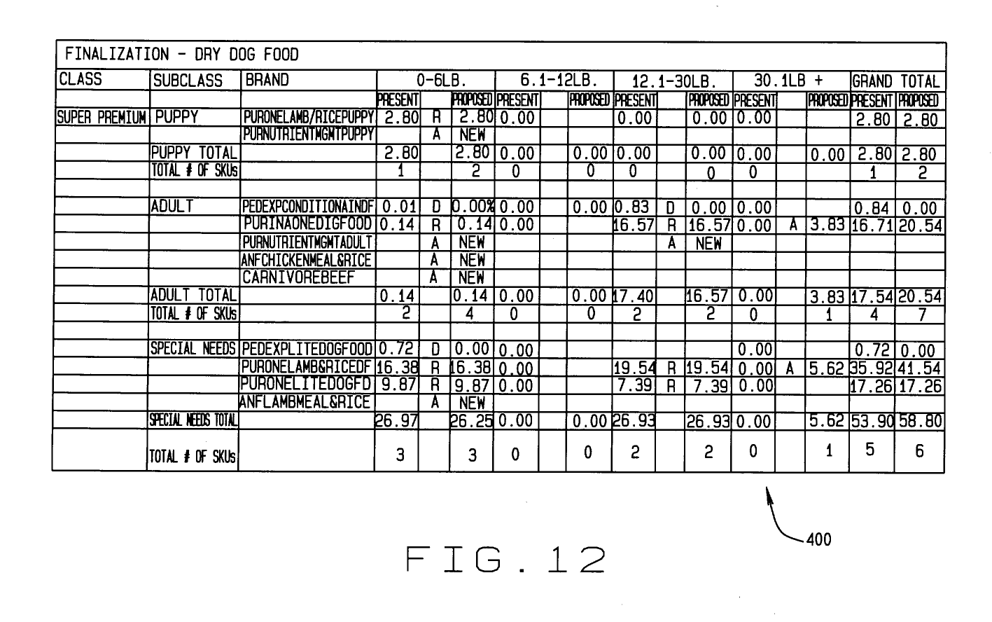

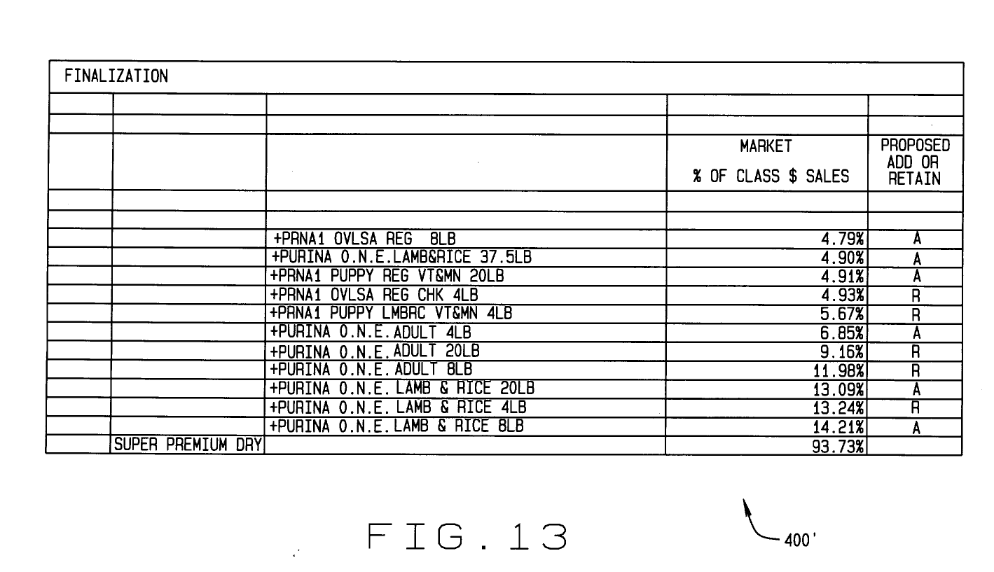

Based upon the changes to the products (e.g., adds, deletes and retains) a finalization worksheet 400 is generated as shown in FIG. 12. A selected number of products are displayed showing pre and post assortment decision worksheet 100 changes preferably by product form, class and size (or flavor), as well as calculated market dollar sales coverage percentage. Confirmation should be provided that the market sales coverage percentage objectives as determined in the tactogram 350 are met. Alternate finalization worksheets 400′ (e.g., condensed information) as shown in FIG. 13 may be generated.

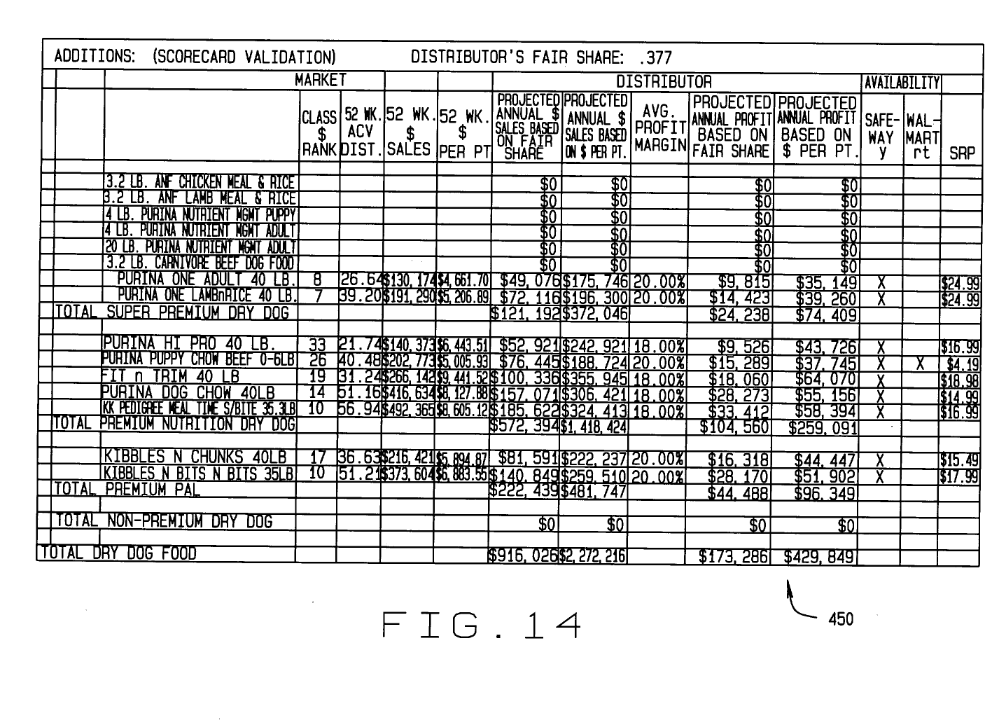

An addition impact worksheet 450 as shown in FIG. 14 is generated by the system 80 and displays a range of sales and profit impacts for the new products (i.e., added) based upon the current market sales dollars and IRI dollar per point calculation. Profits are calculated using the average margin for the product class currently in distribution.

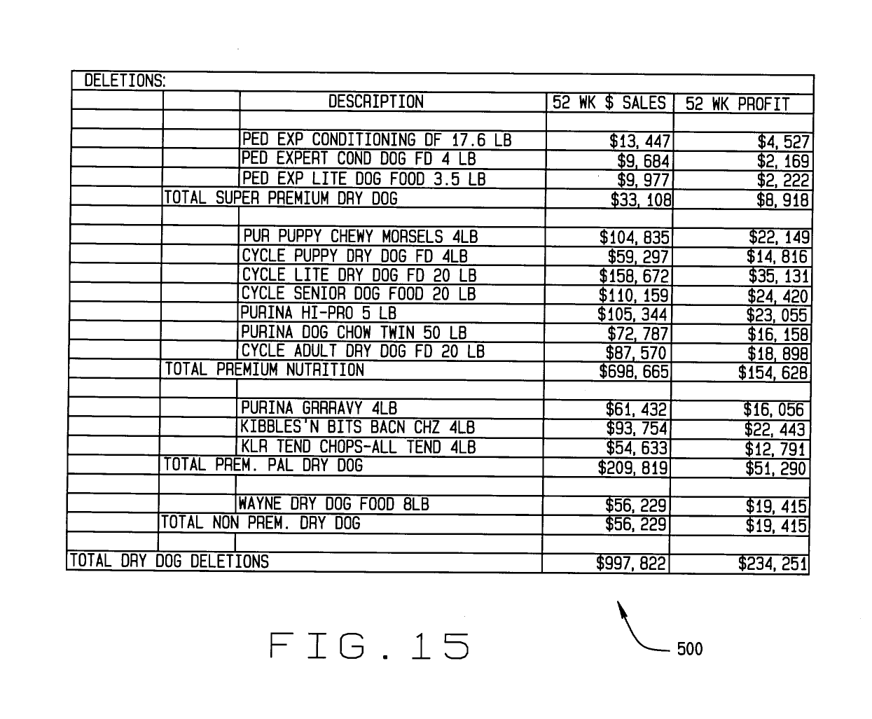

A deletion impact worksheet 500 as shown in FIG. 15 is generated by the system 80 and displays all the products selected for deletion and includes the current 52 week (or 24 week) dollar sales and profits. The results shown in the deletion impact worksheet 500 may be subtracted from the results of the addition impact worksheet 450.

Thus, the finalization worksheet 400, addition impact worksheet 450 and deletion impact worksheet 500 are generated and may be used to confirm the new assortment as compared to an overall strategy, target consumer needs, size, flavors and any opportunity gap issues determined during the assessment process. Further, a presentation program (e.g., Microsoft® PowerPoint) may be used to display the overall results, including defining the strategy used for each sub-category or segment of products, and summarizing financial information.

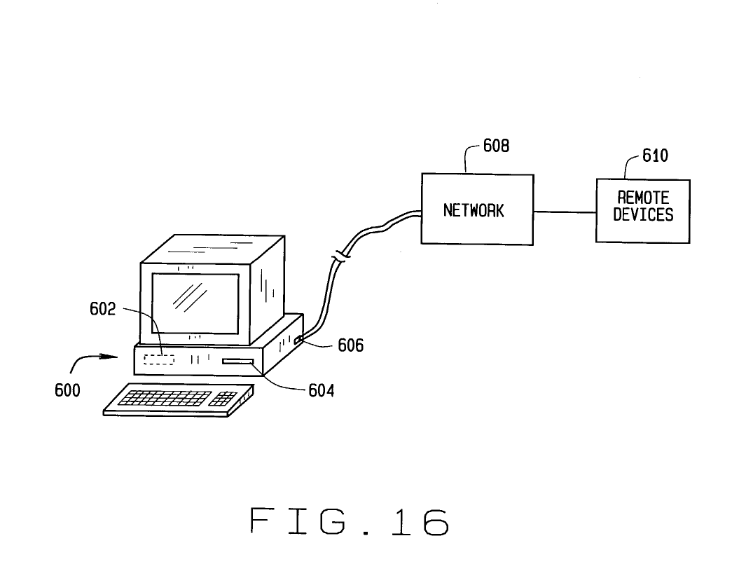

The present invention may be implemented on any computer readable medium capable of causing a computer to provide the system 80. The computer readable medium includes, but is not limited to, a floppy disk, a CD-ROM, a magnetic tape, a hard-disk drive, flash memory and random access memory (RAM). In particular and as shown in exemplary form in FIG. 16, a computer 600 may include an internal storage device 602 (e.g., hard-disk drive) for storing instructions for implementing the system 80 and/or an external reading device 604 (e.g., floppy disk drive) for receiving a computer readable medium (e.g., floppy disk) having instructions recorded thereon for causing a processor of the computer 600, upon executing the instructions, to provide the interface. A network interface 606 (e.g., local area network (LAN) connection) may also be provided as part of the computer 600 to allow for communication with a network 608 having remote devices 610 also connected thereto. The network interface 606 allows for communication of the system 80 to the network 608 and connected remote devices 610.

Although the present invention is described in connection with assortment products using specific factors, it is not so limited, and an assortment process may be provided for different products using different factors.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for evaluating information relating to a group of products for assisting a user in selecting at least some of the products for retail sale, the method comprising:
ranking products within a predetermined product class based upon sales data;
determining a sales threshold for the ranked products;
evaluating ranked products falling within a predetermined range of the sales threshold with reference to consumer preference data; and
selecting products for sale based upon the evaluation.

2. The method according to claim 1 further comprising displaying the selected products on a retail shelf.

3. The method according to claim 1 wherein the sales threshold comprises a combined sales threshold.

4. The method according to claim 1 wherein the evaluating is further performed with reference to the sales data.

5. The method according to claim 1 wherein the sales data comprises profit data for the products.

6. The method according to claim 1 wherein the products are identified by a UPC number.

7. The method according to claim 1 further comprising defining a target group of purchasers when evaluating the ranked products.

8. The method according to claim 6 wherein the selecting comprises adding or deleting products from the group of products based upon the sales threshold and with reference to the consumer preference data.

9. The method according to claim 1 wherein the evaluating comprises using predetermined formulas to select the group of products.

10. The method according to claim 1 wherein the predetermined product class comprises product categories.

11. The method according to claim 10 wherein the product categories comprise product sub-segments.

12. The method according to claim 11 further comprising determining a lower limit for sales of products within a sub-segment.

13. The method according to claim 1 wherein the sales data comprises retailer movement and retailer cost data.

14. The method according to claim 1 wherein the consumer preference data comprises loyalty and switching data.

15. The method according to claim 1 wherein the selecting comprises modifying a previously determined group of products for sale.

16. The method according to claim 15 further comprising comparing the modified group of products to the previously determined group of products.

17. The method according to claim 1 wherein the consumer preference data comprises target consumer information.

18. The method according to claim 1 wherein the sales data comprises target competitor information.

19. The method according to claim 1 further comprising sorting the products by price class.

20. A computer implemented method for processing product and consumer preference information to assist a user in evaluating a group of products to select at least some of the products for retail sale, the method comprising:
receiving the product and consumer preference information relating to each product within the group of products;
processing the product and consumer preference information to rank the products within a predetermined product class based upon sales data; and
displaying the ranked product information in combination with at least some of the product and consumer preference information for use in determining a sales threshold for the ranked products and evaluating the ranked products falling within a predetermined range of the sales threshold with reference to the consumer preference data to select products for retail sale.

21. The computer implemented method according to claim 20 further comprising displaying the product and consumer preference information in at least one worksheet.

22. The computer implemented method according to claim 20 wherein the consumer preference information comprises consumer behavior information.

23. The computer implemented method according to claim 20 wherein the receiving comprises assembling the product and consumer preference information from a plurality of sources.

24. A system for processing product and consumer preference information relating to a group of products, the system comprising
an interface for receiving product and consumer preference information; and
a processor configured to process the product and consumer preference information to produce ranked product information for display in combination with at least some of the product and consumer preference information.

25. The system according to claim 24 wherein the processor is configured to produce the ranked product information for display as part of a worksheet in combination with at least some of the product and consumer preference information, with the worksheet adapted for modification by a user.
